(19) United States
(12) Patent Application Publication
(10) Pub. No.: US 2008/0225997 A1
(43) Pub. Date: Sep. 18, 2008

(54) METHOD AND APPARATUS FOR SYNCHRONIZATION FOR MIMO TDS-OFDM SYSTEM

(75) Inventors: Lin Yang, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/048,353

(22) Filed: Mar. 14, 2008

Related U.S. Application Data
(60) Provisional application No. 60/895,142, filed on Mar. 16, 2007.

(51) Int. Cl. H04L 27/06

(52) U.S. Cl. 375/344

(57) ABSTRACT

In a TDS-OFDM system, frequency offset estimate provided. A method for estimating a frequency offset comprising the step of correlating a known PN sequence with a received signal.

### CROSS-REFERENCE TO OTHER APPLICATIONS

The following applications of common assignee filed on the same day herewith are related to the present application, and are herein incorporated by reference in their entireties:

U.S. patent application Ser. No. ______ with attorney docket number LSFFT-034.

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-041.

### REFERENCE TO RELATED APPLICATIONS

This application claims an invention which was disclosed in Provisional Application No. 60/895,142, filed 16-MAR-2007 entitled “METHOD AND APPARATUS FOR FREQUENCY OFFSET ESTIMATE FOR MIMO TDS-OFDM IN TRANSMISSION”. The benefit under 35 USC § 119(e) of the U.S. provisional application is hereby claimed, and the aforementioned application is hereby incorporated herein by reference.

### FIELD OF THE INVENTION

The present invention relates generally to a TDS-OFDM system, more specifically the present invention relates to frequency offset estimate for TDS-OFDM system in information transmission.

### BACKGROUND

Frequency offset estimate is needed for MIMO TDS-OFDM system transmission, in order to demodulate received TDS-OFDM signals

### SUMMARY OF THE INVENTION

In a TDS-OFDM system, frequency offset estimate is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a MIMO in a TDS-OFDM system in accordance f with some embodiments of the invention.

FIG. 2 is an example symbol in accordance with some embodiments of the invention.

FIG. 3 is an example of a first frequency offset estimate for a TDS-OFDM MIMO receiver in accordance with some embodiments of the invention.

FIG. 4 is an example a second frequency offset estimate for a TDS-OFDM MIMO receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to frequency offset estimate for TDS-OFDM system in information transmission. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of frequency offset estimate for TDS-OFDM system in information transmission described herein. The non-processor circuits may include, but are not limited to, a radio receiver, a radio transmitter, signal drivers, clock circuits, power source circuits, and user input devices. As such, these functions may be interpreted as steps of a method to perform frequency offset estimate for TDS-OFDM system in information transmission. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

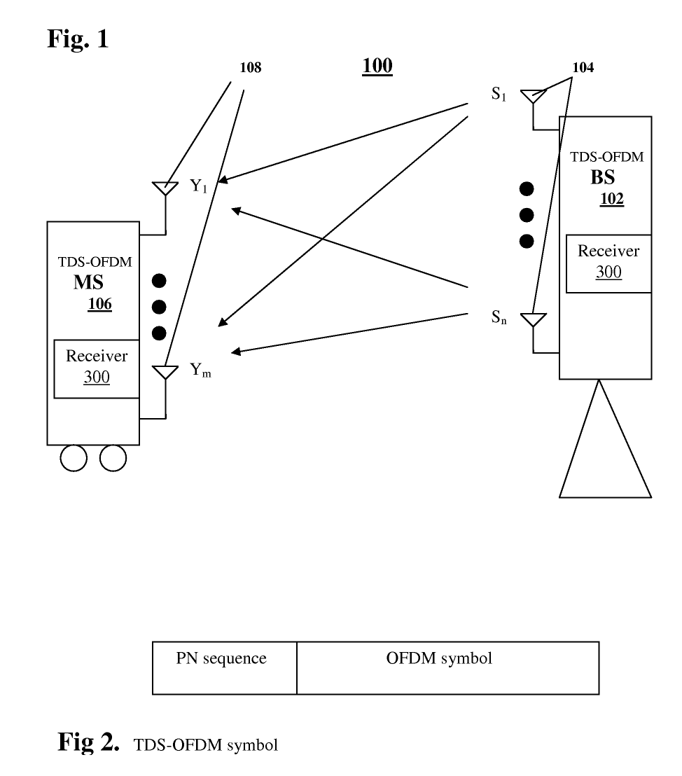

Referring to FIGS. 1-4, a plurality of base stations (BS) 102 (only one shown) each has two or more BS antennas 104. Each one of the antennas 104 respectively transmits signals S₁, S₂, . . . , Sₙ. At least one of the signals Sᵢ among the transmitted signals S₁, S₂, . . . , Sₙ uses the format shown in FIG. 2 employing a pseudo noise (PN) sequence Pᵢ as guard interval that may be among a plurality of PN acting as guard intervals interposed or inserted between data or symbols such as OFDM symbols. Mobile station (MS) 106 receives signals using multiple MS antennas 108. Each one of the antennas 108 is adapted to receive from all transmitted signals including the transmitted signals S₁, S₂, . . . , Sₙ from BS 102 as well as other base stations (not shown). Mobile station 106 comprises a receiver 300 for receiving signals from surrounding base stations. The receiver 300 in mobile station 106 is adapted such that all the PN sequences of substantially all the transmitted signals from substantially all the base stations including BS 102 in a predetermined neighborhood or geographic area are known to the base station 106. In other words, BS 102 and MS 106 know the PN sequences within a wireless communication neighborhood. This is advantageous in a TDS-OFDM system in that the guard intervals are the PN sequences. The receiver 300 is adapted to use the PN codes to perform a correlation in order to find a timing of each path. Both base station 102 and mobile station 106 comprise receivers 300.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

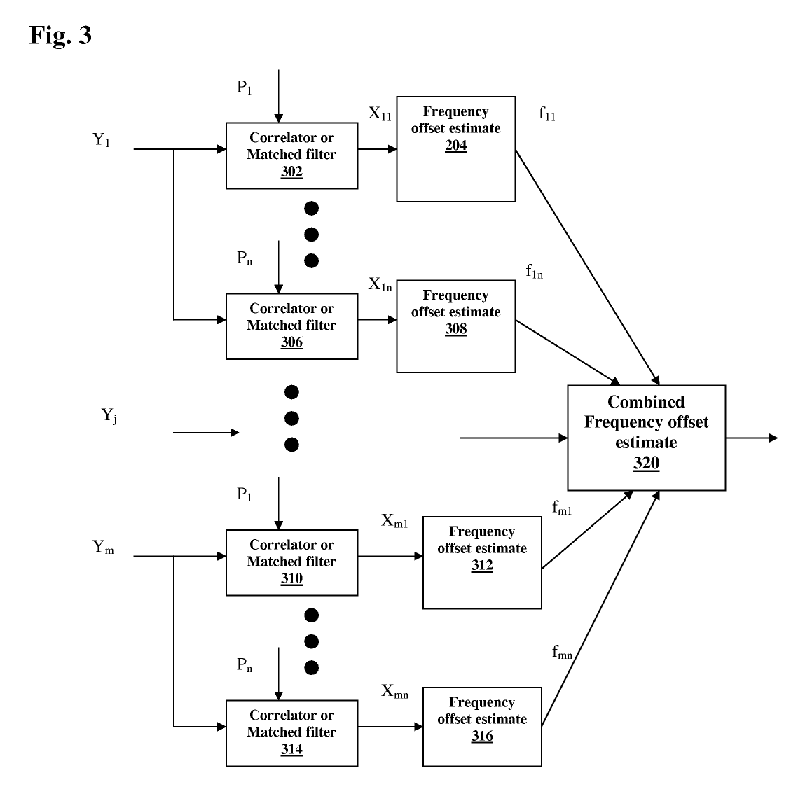

Referring specifically to FIG. 3, the received signals from antenna 1 to m is denoted by Y₁, . . . Yⱼ . . . Yₘ. For Y₁, correlation with a known PN, P₁ is performed by such devices as a matched filter 302 to reach a channel estimation X₁₁. In turn, a frequency offset estimator 304 estimates a particular frequency offset f₁₁. Similarly Y₁ correlates with a known PN, Pₙ is performed by such devices as a matched filter 306 to reach a channel estimation X₁ₙ. In turn, a frequency offset estimator 308 estimates a particular frequency offset f₁ₙ. For example, comparing the phase change of two adjacent channel estimation outputs.

For Yⱼ a similar process (not shown) is performed.

For Yₘ correlation with a known PN, P₁ is performed by such devices as a matched filter 310 to reach a channel estimation Xₘ₁. In turn, a frequency offset estimator 312 estimates a particular frequency offset fₘ₁. Similarly Y₁ correlates with a known PN, Pₙ is performed by such devices as a matched filter 314 to reach a channel estimation Xₘₙ. In turn, a frequency offset estimator 316 estimates a particular frequency offset fₘₙ.

A combined frequency offset estimator 320 using various known combining methods combines the frequency offsets, only a few shown (offset f₁₁, offset f₁ₙ, fₘ₁, fₘₙ).

Base station (BS) transmits signals S₁, S₂, . . . , Sₙ through multiple antennas. Transmitted signal at i-th antenna Sᵢ uses the format in FIG. 2 employing PN sequence Pᵢ. A packet of transmission or a received packet having PN sequence as guard intervals is used herein. The packet is positioned sequentially within a frame among a multiplicity of packets. As can be appreciated, PNs are disposed between the OFDM symbols.

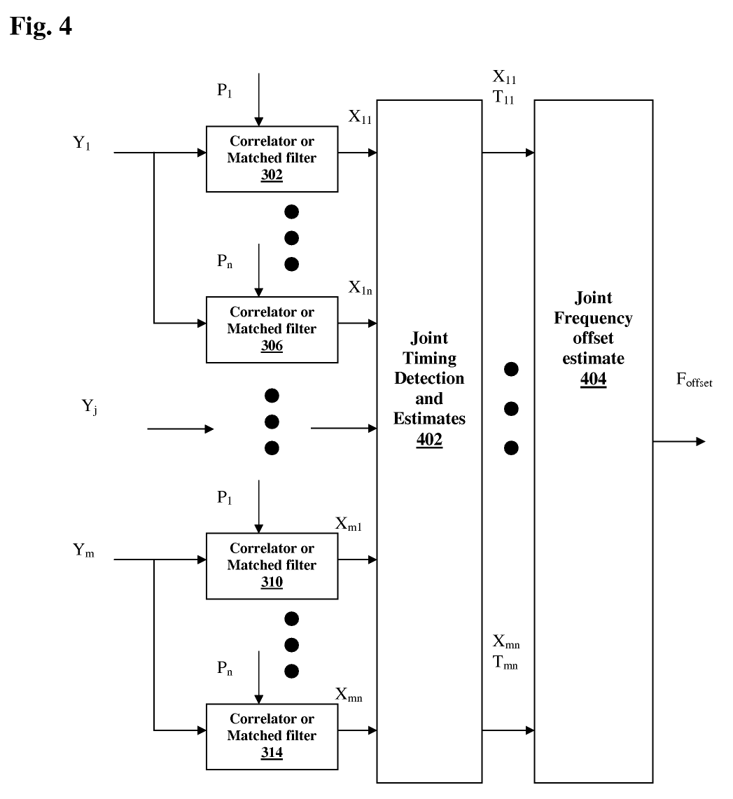

Referring specifically to FIG. 4, a Frequency offset estimate for TDS-OFDM MIMO receiver is shown. The received signals from antenna 1 to m is denoted by Y₁, . . . Yⱼ . . . Yₘ. For Y₁, correlation with a known PN, P₁ is performed by such devices as a matched filter 302 to reach a channel estimation X₁₁. Similarly Y₁ correlates with a known PN, Pₙ is performed by such devices as a matched filter 306 to reach a channel estimation X₁ₙ.

For Yⱼ a similar process (not shown) is performed.

For Yₘ correlation with a known PN, P₁ is performed by such devices as a matched filter 310 to reach a channel estimation Xₘ₁. Similarly Y₁ correlates with a known PN, Pₙ is performed by such devices as a matched filter 314 to reach a channel estimation Xₘₙ.

The channel estimations (only some shown including (X₁₁, X₁ₙ, Xₘ₁, Xₘₙ) are further subjected to a join timing detector or estimator 402. The outputs of block 402 is further subjected to a joint frequency offset estimator to obtain a frequency offset.

Base station (BS) transmits signals S₁, S₂, . . . , Sₙ through multiple antennas. The transmitted signal at i^{th} antenna Sᵢ uses the format as shown in FIG. 2 employing PN sequence Pᵢ. Mobile station (BS) receives signals using multiple antennas. Received signal at j^{th} antenna is Yⱼ. Received signal at j^{th} antenna Yⱼ receives signals from all transmitted signals. The receiver knows the PN sequences of all transmitted signals from all neighboring BS in a predetermined region. The receiver uses PN code to perform correlation to find frequency offset of each path. The receiver uses the frequency offset estimates from all paths to further estimate a combined frequency offset estimate. Carrier frequency is only a single one.

Referring again to FIG. 4, the receiver may first detect and estimate timing and then use the PN codes from all paths to perform joint frequency estimate.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for estimating a frequency offset comprising the step of correlating a known PN sequence with a received signal.

2. The method of claim 1, wherein a receiver uses PN code to perform correlation to find at least one frequency offset.

3. The method of claim 1, wherein a receiver uses the frequency offset estimates from a plurality of paths to estimate a combined frequency offset estimate.

4. The method of claim 1, wherein a receiver first detect and estimate a timing and then use the PN sequence from a plurality of paths to perform a joint frequency estimate.

5. The method of claim 1, wherein PN sequences are guard intervals.
